(19) United States
(12) Patent Application Publication
(10) Pub. No.: US 2012/0166266 A1
(43) Pub. Date: Jun. 28, 2012

(54) ENABLING A SECOND SYSTEM TO MANAGE SELECTED ANONYMOUS USERS OF A FIRST SYSTEM IN A PERFORMANCE OF A TASK

(75) Inventors: Narasimhan Rampalli, Los Altos, CA (US); Hiu Pok Lau, San Jose, CA (US)

(73) Assignee: eBay Inc., San Jose, CA (US)

(21) Appl. No.: 12/976,115

(22) Filed: Dec. 22, 2010

(51) Int. Cl. G06Q 30/00

(52) U.S. Cl. 705/14.19; 705/14.1

(57) ABSTRACT

In a method of enabling a second system to manage selected anonymous users of a first system in a performance of a task, a rule is received from a second system, the rule specifying a criterion for a selection of a user from a plurality of users of the first system. A user is selected from the plurality of users, the selecting based on the criterion, the selecting including searching a record of a database, the record containing data pertaining to an activity of the user with respect to the first system, the database being inaccessible to the second system. A request is forwarded from the second system to the user, the request requesting that the user perform a task. A result is sent to the second system, the result including information pertaining to a performance of the task by the user.

### TECHNICAL FIELD

The present application relates generally to the technical field of task management, and, in one specific example, to enabling a second system to manage selected anonymous users of a first system in a performance of a task.

### BACKGROUND

A network-based publication system (e.g., EBAY®, AMAZON®, or CRAIGSLIST®) may maintain information pertaining to users of the network-based publication system. The network-based publication may receive such information from the users themselves. For example, when creating an account to access the network-based publication system, a user may provide information by which the user can be identified (e.g., name, address, phone number, email address, and so on). Additionally, when creating a profile on the network-based publication system, a user may share personal information about himself (e.g., profession, employer, interests, and so on) with the general public or other users of the network-based publication system.

Additionally, the network-based publication system may obtain such information by monitoring the activities of users with respect to the network-based publication system. For example, the network-based publication system may monitor and store data pertaining to activities of users with respect to buying items, selling items, or performing other actions on the network-based publication system.

This information pertaining to the users of the network-based publication system may be valuable to parties external to the network-based publication system. Nevertheless, for various reasons, the network-based publication system may wish to keep at least a portion of this information private from the external parties.

### BRIEF DESCRIPTION OF THE DRAWINGS

Some embodiments are illustrated by way of example and not limitation in the figures of the accompanying drawings in which:

FIG. 1 is a block diagram illustrating an environment in which an integration system executes, according to some example embodiments;

FIG. 2 is a block diagram illustrating modules of the integration system, according to some example embodiments;

FIG. 3 is a flowchart illustrating an example method by which the integration system enables the external system to manage users of the network-based publication system in a performance of a task;

FIG. 4 is a is a block diagram illustrating an example embodiment of a database in which the network-based publication system maintains information about users of the network-based publication system;

FIG. 5 is a flowchart illustrating a method by which the integration system or a party external to the integration system may incentivize selected users of the network-based publication system to perform a task; and

FIG. 6 is a block diagram illustrating an example computer system on which methodologies described herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A method of enabling a second system to manage selected anonymous users of a first system in a performance of a task is disclosed. A rule is received from a second system, the rule specifying a criterion for a selection of a user from a plurality of users of the first system. A user is selected from the plurality of users, the selecting based on the criterion, the selecting including searching a record of a database, the record containing data pertaining to an activity of the user with respect to the first system, the database being inaccessible to the second system. A request is forwarded from the second system to the user, the request requesting that the user perform a task. A result is sent to the second system, the result including information pertaining to a performance of the task by the user.

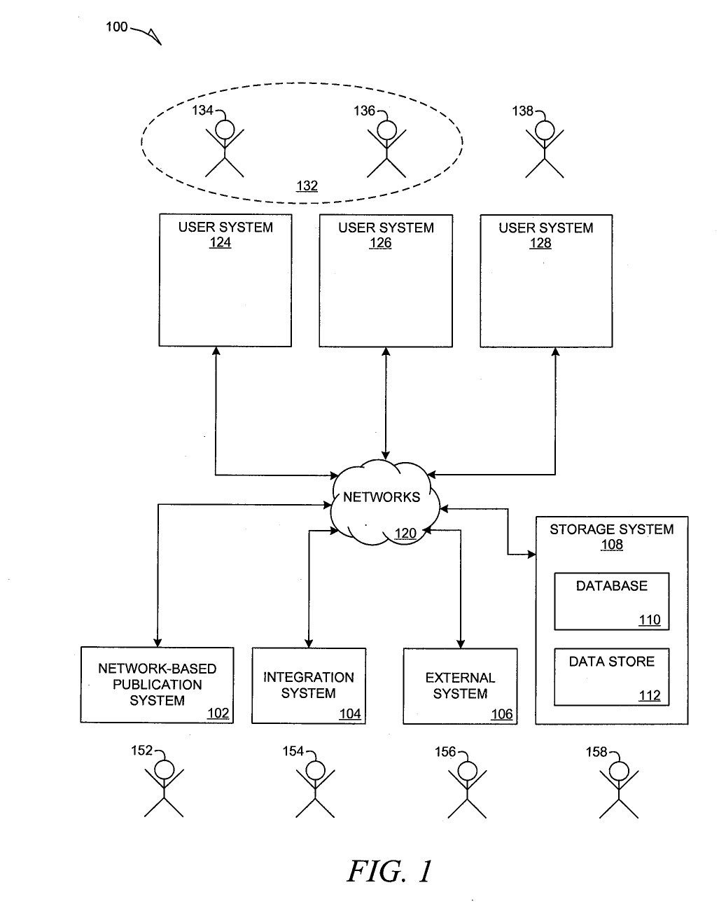

FIG. 1 is a block diagram illustrating an environment 100 in which an integration system 104 executes to enable a system 106 external to a network-based publication system to manage a subset 132 of users (e.g., users 134-138) of the network-based publication system 102 in a performance of a task, according to some example embodiments.

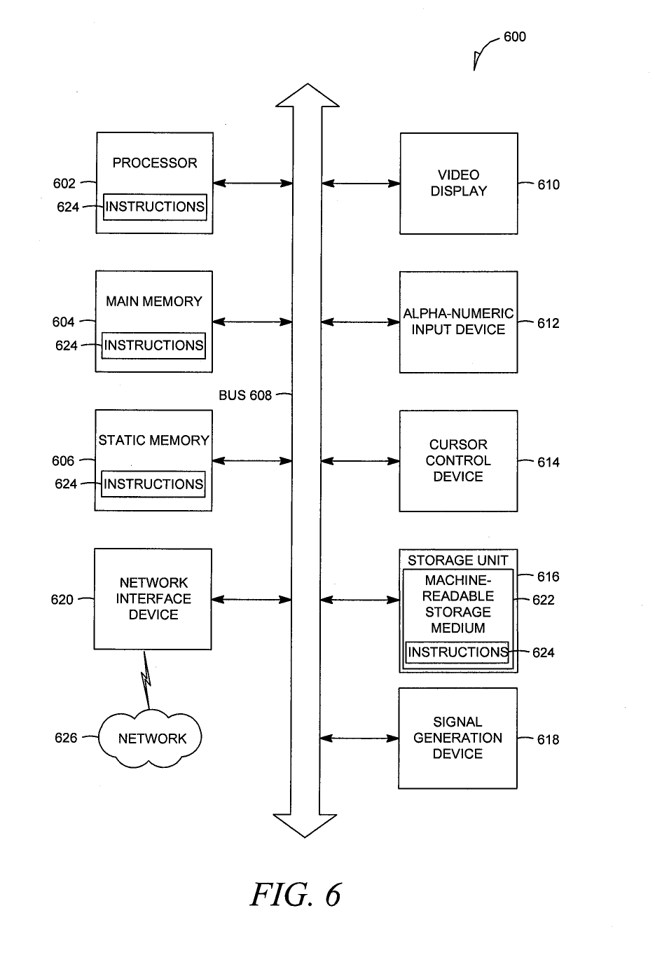

The environment 100 includes the users 134-138. As used herein, a “user” is a person or a machine. The users 134-138 may be users of one or more of the systems 102-108. For example, the users 134-138 may be users of the network-based publication system 102. The users 134-138 may access one or more of the systems 102-108 via user systems 124-128. Each of the user systems 124-128 (as well as systems 102-108) may be a computer system, such as the computer system 600 of FIG. 6. Examples of user systems 124-128 may be personal computers, personal digital assistants, smart phones (e.g., an iPhone), and so on.

The environment 100 includes the network-based publication system 102. As used herein, a “network-based publication system” is a system that is connected to a network and publishes information via the network. The information may include information pertinent to one or more products or one or more items.

As used herein, a “product” refers to a good or a service of which one or more specimens may be listed by a network-based publication system (e.g., as being available for purchase). Examples of products include a specific brand of shaver having a specific model number, a specific brand of gaming console having a specific color, or a specific brand of digital recorder having a specific storage capacity. Other examples of products include downloadable data (e.g., video, music, or electronic books), an authorization to use downloadable data (e.g., a license), and an obligation to perform a service (e.g., technology consulting or an astrology reading).

As used herein, an “item” is a specimen of a product. Examples of items include a particular shaver (e.g., a single unit), a particular gaming console, or a particular digital recorder. Other examples of items include a particular copy of downloadable data (e.g., a video file, a music file, or an electronic book file), a particular authorization allowing a particular person to use downloadable data, and a particular obligation to perform a service for a particular person.

The network-based publication system 102 may be an electronic commerce system. Examples of network-based publication systems include EBAY®, AMAZON®, and CRAIGSLIST®.

The network-based publication system 102 may maintain information pertaining to the users 134-138 of the network-based publication system. Such information may include information received by the network-based publication system 102 from the users 134-138 or information collected by the network-based publication system 102 with respect to actions performed by the users 134-138 on the network-based publication system 102.

The environment 100 includes a storage system 108. The storage system 108 may include one or more databases 110 or data stores 112. The network-based publication system 102 may store data, such as the information pertaining to the users of the network-based publication system 102, in the storage system 108.

The environment 100 includes the external system 106. The external system 106 is a system that does not have access to at least some of the information pertaining to users of the network-based publication system 102. The external system 106 may be a system operated by a third party. For example, the third party may be a company that is involved in manufacturing, distributing, or selling one or more products that users of the network-based publication system buy or sell. Or the third party may be a company having a business relationship (e.g., an advertising relationship) with a party that operates the network-based publication system 102.

The environment 100 includes an integration system 104. The integration system 104 may enable the external system 106 to manage a subset (e.g., subset 132) of the users (e.g., the users 134-138) of the network-based publication system 102 in the performance of a task. For example, the integration system 104 may provide the external system 106 with an abstraction of the information pertaining to the users of the network-based publication system. The abstraction of the information may include demographics or a demography of the users of the network-based publication system 102. The abstraction may provide the external system 104 with information by which it may make a determination regarding the selection of a subset of the users to manage in the performance of the task. The abstraction may preserve anonymity of the users with respect to the external system 106.

The integration system 104 may handle communications between the external system 104 and the users or a selected subset of the users of the network-based publication system 102. For example, the integration system 104 may forward requests from the external system 106 that particular users perform a task to the particular users. Or the integration system 104 may send updates to the external system 106 regarding the status of a performance of the task by the users or the subset of users.

The integration system 104 may provide a user interface (e.g., a web site) by which the external system 106 may perform various tasks, such as receiving an abstraction of the information pertaining to the users of the network-based publication system, selecting a subset of users of the network-based publication system based on the abstraction, specifying requests to send to the selected subset of users regarding the performance of a task by the selected subset of users, and receiving updates on the performance of tasks by the selected subset of users.

The environment 100 includes system administrators 152-158. Among other things, the system administrators 152-158 may be responsible for configuring various policies governing the access of respective systems 102 and 108 by the users 134-138.

The environment 100 includes one or more networks 120. The networks 120 enable communication between the systems 102-108 and 124-128. Examples of the networks 120 include local area networks (LANs), wide area network (WANs), and global area network (GANs) (e.g., the Internet).

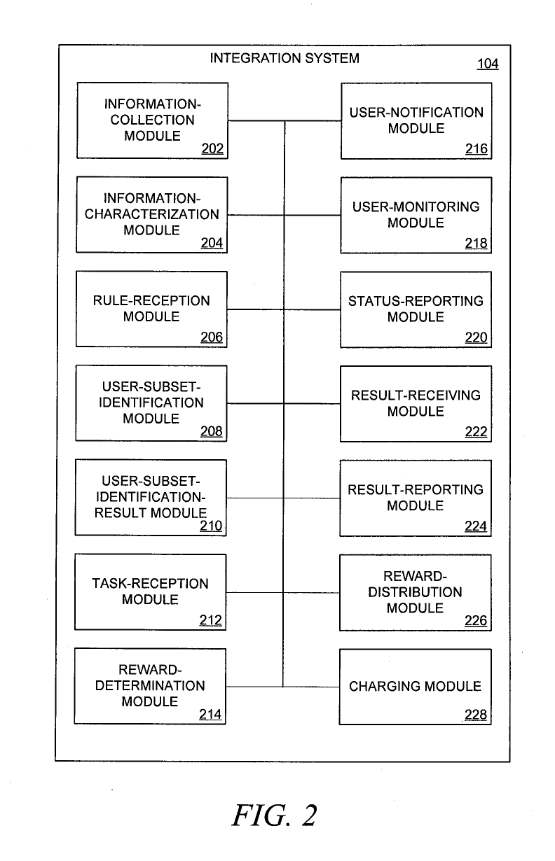

FIG. 2 is a block diagram illustrating modules of the integration system 104, according to some example embodiments. The integration system 104 includes an information-collection module 202 that is configured to collect information about users of the network-based publication system 102, an information-characterization module 204 that is configured to characterize the information about the users and to communicate the characterization of the information to the external system 106, and a rule-reception module 206 that is configured to receive (e.g., from the external system 106) one or more rules for selecting a subset of the users of the network-based publication system 102.

The integration system 104 also includes a user-subset-identification module 208 that is configured to identify a subset of the users of the network-based publication system 102 based on the received rules, a task-reception module 212 that is configured to receive a request that the subset of users perform one or more tasks, and a reward-determination module 214 that is configured to determine one or more rewards to offer to one or more users of the subset in exchange for the users completing the tasks.

The integration system 104 also includes a user-notification module 216 that is configured to notify users of the tasks and the rewards, a user-monitoring module 218 that is configured to monitor the subset of the users with respect to their progress toward completing the tasks, and a status-reporting module 220 that is configured to report (e.g., to the external system 106) the status of the subset of the users in terms of completing the tasks.

The integration system 104 also includes a result-receiving module 222 that is configured to receive results of the completion of the tasks by the users (e.g., a completed survey), a result-reporting module 224 that is configured to communicate the results of the completion of the tasks by the users (e.g., to the external system 106), a reward-distribution module 226 that is configured to distribute user-specific rewards to each user of the subset based on the completion of the task by the user, and a charging module 228 to charge a party a pre-determined amount of money for interacting with the integration system 104 (e.g., to manage the performance of a task by selected anonymous users of the network-based publication system 102).

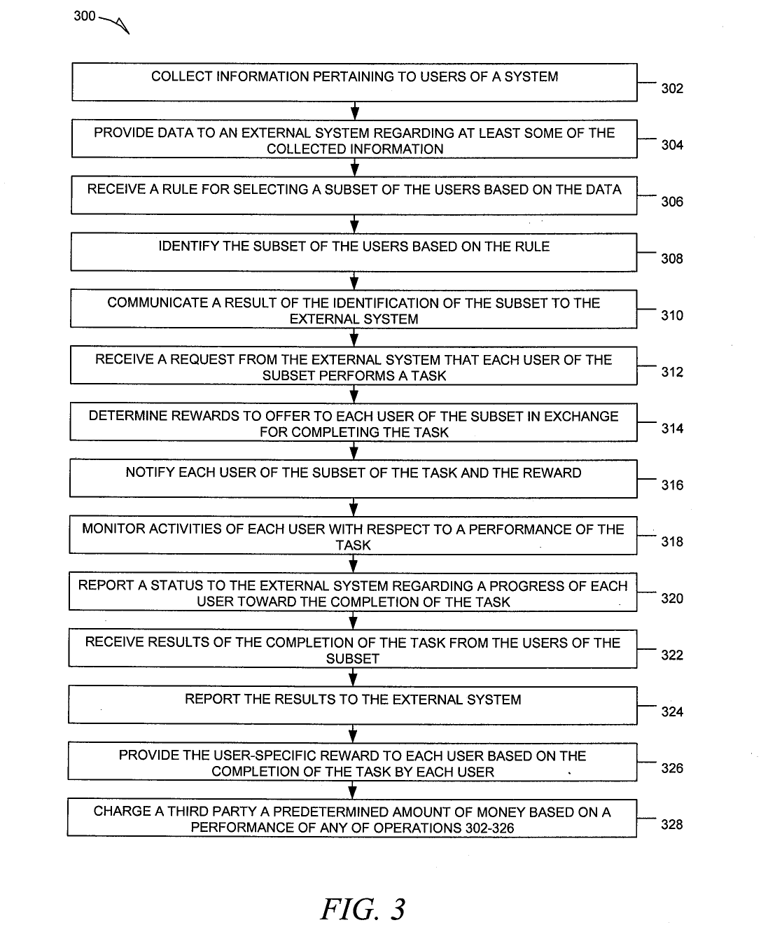

FIG. 3 is a flowchart illustrating an example method by which the integration system 104 may enable the external system 106 to manage users of the network-based publication system 102 in a performance of a task.

At operation 302, the information-collection module 202 collects information pertaining to users of the network-based publication system 102. The information-collection module 202 may collect some of such information from the users themselves. For example, when the user 134 creates an account for accessing the network-based publication system 102, the information-collection module 202 may receive various types of information from the user 134, such as his name, email address, home or registration address, shipping address, payment or purchase pickup address, return address, instant messenger account information, credit card information, checking account information, other account (e.g., PayPal account) information, preferred method of backing up payments, preferred method of making automatic payments, communication or notification preferences, or web site preferences.

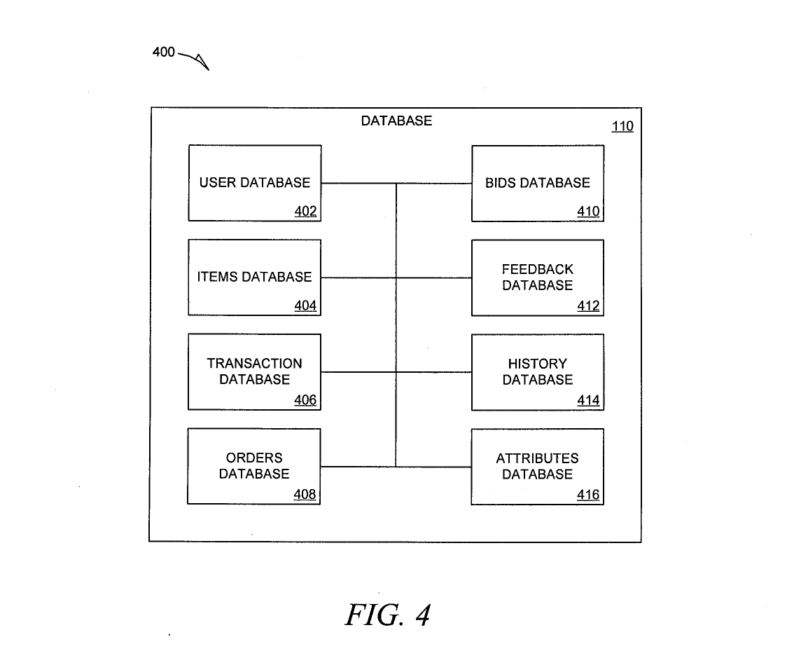

The information-collection module 202 may also collect some information pertaining to the users of the network-based publication system 102 by monitoring activities of the users with respect to the network-based publication system 102. For example, the information-collection module 202 may maintain data pertaining to feedback received from or left for a user, seller account information (e.g., a current balance of a seller account), reward points (e.g., eBay Bucks) account information, donation account information, user subscriptions to various services offered by the network-based publication system 102, or information pertaining to resolutions of problems between users regarding transactions conducted by the users on the network-based publication system 102. The information-collection module 202 may maintain records of transactions conducted on the network-based publication system 102. Such transaction records may include information about items bought and sold on the network-based publication system 102, such as the brand or model number of the item and the agreed-upon purchase price for the item. The information-collection module 202 may collect any of the data maintained by the network-based publication system 102, such as data stored in the data storage system 108. This data is described in more detail below with respect to FIG. 4.

At operation 304, the information-characterization module 204 characterizes the information collected at operation 302 and communicates the characterization to the external system 106. The characterization of the collected information may include data regarding the information, but not the information itself. In this way, the information itself may remain private to the network-based publication system 102 or the integration system 104. That is, the information itself may not be shared with the external system 106. The data may include the types of information collected at operation 302. For example, the information-characterization module 204 may specify that the network-based publication system 102 maintains information pertaining to the age, gender, income level, race, or ethnicity, of each of the users. Or the integration system 104 may indicate that the network-based publication system 102 maintains information concerning items purchased or sold by each of the users on the network-based publication system 102. In this case, the integration system 104 may indicate that such information includes the brand and model number of the item as well as the date of the sale or purchase of the item.

The information-characterization module 204 may also determine possible values and value ranges for each type of information collected at operation 302 and communicate the possible values and value ranges to the external system 106. For example, if one type of information collected at operation 302 is the age of the users, the integration system 102 may also specify an age range of the users (e.g., between 16 and 102).

The information-characterization module 204 may include in the characterization only a particular subset of the types of information that the network-based publication system 102 maintains with respect to each of the users. For example, the information-characterization module 204 may identify the particular subset of the types of information based on a balancing of a request by the external system 106 to obtain specific information about the users and a request by the users of the network-based publication system 104 to keep the specific information private from the external system 106.

The information-characterization module 204 may communicate the characterization via a user interface (e.g., via a web site). For example, the information-characterization module 204 may serve a web page that includes the characterization. The user interface may serve as a central location at which the external system 106 may interact with the integration system 104 (e.g., when the integration system performs 104 any of operations 302-328).

At operation 306, the rule-reception module 206 receives a rule for selecting a subset of the users of the network-based publication system 102. The rule may be based on the characterization of the information pertaining to the users of the network-based publication system 102 that was communicated to the external system 106 at operation 204. The rule may specify one or more criteria for making the selection. For example, the rule may specify that each user of the subset must have a particular age (e.g., 21) or have an age that falls within a particular age range (e.g., 21-25). In fact, the rule may specify any criteria relating to particular values or value ranges for any of the types of information that the network-based publication system 102 collects at operation 302 and exposes to the external system 106 at operation 304. The rule may also specify a minimum number of users of the network-based publication system that must complete the task. For example, the rule may specify that 10 users must complete the task or that 2,000 users must complete the task.

The rule-reception module 206 may perform data validation on the values or value ranges included in the rule. That is, the rule-reception module 206 may enforce restrictions on values of particular types of information to particular values or ranges of values. For example, the rule-reception module 206 may reject a rule that requires each user of the subset of users to have an age of less than 16. Or the rule-reception module 206 may reject a rule that specifies a minimum number of users that is greater than a particular number (e.g., 10,000).

The rule-reception module 206 may provide a user interface (e.g., via a central web site) by which the external system 106 may specify a rule. For example, the rule-reception module 206 may present possible selection criteria and respective values (as determined by the information-characterization module 204 at operation 304) as selectable user interface elements on a form. A user may then specify the rule by selecting one or more criteria and corresponding values. The rule-reception module may receive the rule upon a submission of the form by the user.

At operation 308, the user-subset-identification module 104 identifies a subset of users of the network-based publication system 102 matching the criteria specified in the rule. For example, if the rule received at operation 304 specifies that each of the subset of users must be between 21 and 26 years old and must have purchased a particular brand of a particular product within a particular time frame, the user-subset-identification module 208 may search the database 106 to identify users that match these criteria.

At operation 310, the user-subset-identification-result module 208 communicates the results of the identification of the subset of the users (e.g., to the external system 106 via the central user interface). The results may be communicated to the external system 106 such that the identity of each of the users remains private to the network-based publication system 102. For example, the user-subset-identification-result module 208 may simply communicate a number of users within the system that match one or more criteria specified in the rule. Or the user-subset-identification-result module 208 may provide demographic data associated with each of the users of the network-based publication system 102 that match the criteria specified in the rule. Thus, the user-subset-identification-result module 208 may provide abstract information about particular users to the external system 106 without exposing concrete information about the particular users, such as the names, addresses, or phone numbers, of the particular users. The user-subset-identification-result module 208 may also associate an identifier with each user of the subset. The user-subset-identification-result module 208 may provide these identifiers to the external system 106 such that the external system 106 may later identify or manage particular users of the subset individually.

At operation 312, the task-reception module 212 may receive a request (e.g., from the external system 106) that the selected subset of users perform a particular task. For example, the task-reception module 212 may receive a request that the selected subset of users respond to a survey regarding a product that the users recently purchased. The survey may relate to how the purchasers perceive the user interface of the product. As another example, task-reception module 212 may receive a request that the subset of users provide feedback on a third-party web site pertaining to a type of the product (e.g., paint) that the subset of users may have a particular expertise in (e.g., based on buying and selling activities of the users on the network-based publication system 102).

At operation 314, the reward-determination module 214 may determine a reward to offer to all or particular ones of the subset of users in exchange for completing the task. The determination of the reward may be based on various factors, including the number of users in the subset, the difficulty of the task, the completion time of the task, or input from the external system 106. The value of the reward offered to each user may vary based on information about each of the users that is private from the external system 106, such as the activity level of each user with respect to the network-based publication system 102. For example, more active users may receive an offer having relatively higher value than less active users. The reward may be determined and provided by the integration system 104 (e.g., via the reward-determination module 214), the external system 106, or a combination of both systems. For example, input about the reward (e.g., the type or value of the reward to offer to various ones of the subset of the users) or an agreement regarding whether a party associated with the external system will provide the reward may be received from the external system 106 via the central user interface. The reward may be cash, reward points (e.g., eBay Bucks), coupons, merchandise, and so on, or any combination of such rewards.

At operation 316, the user-notification module 216 may notify each of the subset of the users or particular ones of the subset of the users of the task. The user-notification module 216 may also specify, for each user, the reward, if any, that the user will receive for completing the task. For example, the user-notification module 216 may forward the request to a particular number of the subset (e.g., 100 users of the subset). The user-notification module 216 may prioritize which users of the subset of users to forward the request based on information about the users that is private from the external system 106, such as the activity levels of the users with respect to the network-based publication system 102. For example, the user-notification module 216 may forward the request to each of the 100 users of the subset who have sold the most items on the network-based publication system 102 in the last month, and communicate the associated user-specific reward, if any, to each user.

At operation 318, the user-monitoring module 218 may monitor an activity of the user with respect to the request. For example, the user-monitoring module 218 may detect when the user has received the request. As another example, the user-monitoring module 218 may detect a progress of the user toward a completion of the task. Thus, if the task is to complete a survey regarding an aspect of a product, the user-monitoring module 218 may monitor how many or a percentage of questions on the survey that the user has answered.

At operation 320, the status-reporting module 220 may report on the status of each of the subset of the users with respect to the completion of the request. For example, the status-reporting module 220 may communicate the status of each of the users of the subset to the external system 106 via the central user interface.

At operation 322, the result-receiving module 222 may receive one or more results of the completion of the task from one or more of the subset of users. For example, if the task is to complete a survey, the result-receiving module 222 may receive a completed survey from one or more users of the subset, indicating that those users have completed the task.

At operation 324, the result-reporting module 224 may report a result of a completion of the task to the external system 106. For example, the result-reporting module 224 may communicate each result received from each user of the subset to the external system 106. Or the result-reporting module 224 may communicate a summary of the results to the external system 106. For example, if the result from each user is a completed survey form, the result-reporting module 224 may report, via the central user interface, a summary of the results that shows a breakdown of received answers to the questions of the survey by percentage.

At operation 326, the reward-distribution module 226 may provide the offered reward, if any, to the users, based on the completion of the task by the users. For example, the reward-distribution module 226 may increment a stored value account of a user by an amount of the reward.

At operation 328, the charging module 228 may charge a party associated with the external system 106 a pre-determined amount of money for enabling the external system 106 to manage the subset of the users in the completion of the task (e.g., for performing any of the operations 322-328). For example, the charging module 228 may decrement a stored value account associated with the party by a pre-determined amount in exchange for reporting the results to the external system at operation 324. The party may provide information about the stored value account and agree to the pre-determined charges when creating an account to interact with the integration system 106 via the central user interface.

FIG. 4 is a block diagram illustrating an example embodiment of the database 110 of FIG. 1. The network-based publication system 102 may store the data it collects (e.g., at operation 302) into one or more databases of database 110. The database 110 may include a user database 402, an items database 404, a transaction database 406, an orders database 408, a bids database 410, a feedback database 412, a history database 414 or an attributes database 416. The user database 402 may include a record for each registered user of the network-based publication system 102, and may include identifier, address, and financial instrument information pertaining to each such registered user. A user may operate as a seller, a buyer, or both, within the network-based publication system 102. In one example embodiment, a buyer may be a user that has accumulated value (e.g., commercial or proprietary currency), and is accordingly able to exchange the accumulated value for items that are offered for sale at the network-based publication system 102.

The items database 404 may include item records for goods and services that are available to be, or have been, transacted via the network-based publication system 102. A transaction database 406 may include a record for each transaction (e.g., a purchase or sale transaction) pertaining to items for which records exist (e.g., within the items database 404). The orders database 408 may include order records, with each order record being associated with an order. Each order, in turn, may be associated with one or more transactions for which records exist (e.g., within the transaction database 406).

The bids database 410 may include a bid record for each bid received at the network-based publication system 102 in connection with an auction-format listing of an item. The feedback database 412 may include records containing reputation information concerning users. The history database 414 may include records pertaining to a history of transactions to which a user has been a party. The attributes database 416 may include records containing attribute information pertaining to items for which records exist (e.g., within the items database 404). Considering only a single example of such an attribute, the attributes databases 416 may indicate a currency attribute associated with an item, with the currency attribute identifying the currency of a price for the relevant item as specified by a seller. Each record within each of the databases may be linked to one or more records within other ones of the database, so as to, for example, associate a seller and one or more actual or potential buyers with an item.

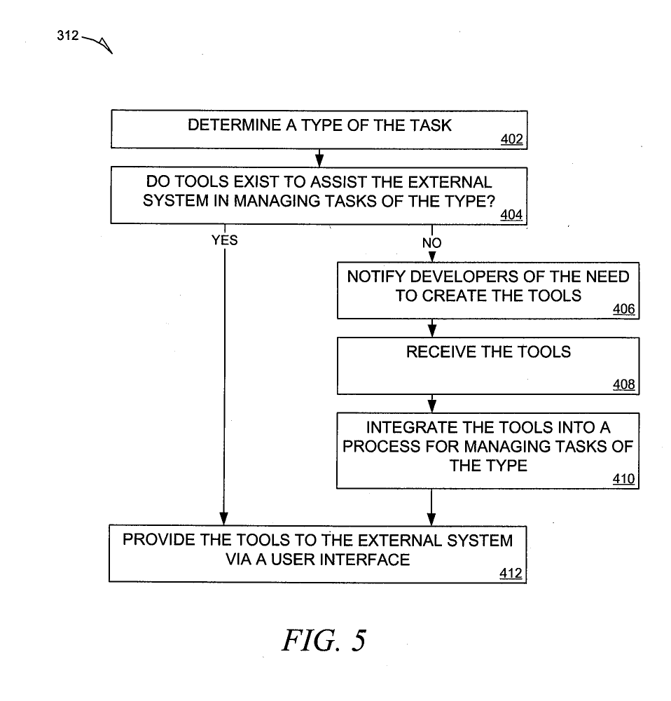

FIG. 5 is a flowchart illustrating example operations that operation 312 of FIG. 3 comprises. At operation 402, the task-reception module 212 determines a type of the task associated with the request. The possible types may be predetermined by the administrator 154 of the integration system 104. For example, the task-reception module 212 may determine whether the task relates to one of the predetermined types of completing a survey, gathering media data, or testing a software product. The task-reception module 212 may communicate the possible types of tasks, as well as an “other” option, to the external system 106 for selection via the central user interface. The “other” option may allow the external system 106 to specify a type of task that is not one of the predetermined types of tasks.

At operation 404, the task-reception module 212 determines whether tools exist to assist the external system in managing tasks of the determined type. Examples of such tools may include a survey-builder tool (e.g., for tasks of the type “survey administration”) to enable the external system 106 to construct a survey for distribution to the subset. Another example of a tool may include a web site (e.g., for tasks of the type “media data collection”) at which the subset may submit requested media data objects. If the external system 106 selects an “other” option when specifying the type of the task, the task-reception module 212 may automatically determine that no tools exist. If the tools exist, the operations continue at operation 412. Otherwise, the operations continue at operation 406.

At operation 406, the task-reception module 212 notifies users (e.g., software developers) of the need to create tools to assist the external system 106 in the managing particular types of tasks. For example, if the task-reception module 212 receives a new type of task related to gathering universal product codes (UPCs) for a range of products, the task-reception module 212 may notify the users of the need to create a tool to assist the external system 106 in managing tasks of this type.

At operation 408, the task-reception module 212 may receive one or more tools related to tasks of the specified type. For example, the task-reception module 212 may receive a tool for validating UPCs that the external system 106 can use to manage the subset of users in completing tasks related to gathering UPCs.

At operation 410, the task-reception module 212 integrates the received tools into a process for managing tasks of a particular type. For example, the task-reception module 212 may add the new type (e.g., “UPC collection”) to the list of predetermined types of tasks. The task-reception module 212 may also associate the received tool with the type, such that the external system 106 may use the tool when submitting a request that the subset of users perform tasks of the new type.

At operation 412, the task-reception module 212 provides the tools to the external system 106 via the central user interface. For example, if the task-reception module 212 determines that the type of the task relates to survey administration, the task-reception module 212 may provide a tool by which the external system 106 can build a survey. The task-reception module 212 may then receive a constructed survey from the external system 106 as part of operation 312.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 120) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 626 may be one of the networks 120.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
at a first system:
receiving a rule from a second system, the rule specifying a criterion for a selection of a user from a plurality of users of the first system;
selecting, using a processor, the user from the plurality of users, the selecting based on the criterion, the selecting including searching a record of a database, the record containing data pertaining to an activity of the user with respect to the first system, the database being inaccessible to the second system;
forwarding a request from the second system to the user, the request requesting that the user perform a task; and
sending a result to the second system, the result including information pertaining to a performance of the task by the user.

2. The method of claim 1, further comprising:
at the first system:
sending a summary of the data to the second system, the summary preserving an anonymity of the user; and
wherein the criterion for the selection of the user is based on the summary.

3. The method of claim 1, further comprising:
monitoring a performance of the task by the user; and
wherein the result includes information pertaining to the monitoring of the performance of the task by the user.

4. The method of claim 1, further comprising:
at the first system:
determining a reward to offer to the user in exchange for the performance of the task by the user;
notifying the user of the reward; and
providing the reward to the user in response to the performance of the task by the user.

5. The method of claim 1, wherein:
the first system is a network-based publication system;
the activity is at least one of a buying of a product using the first system and a selling of the product using the first system; and
the task relates to the product.

6. The method of claim 1, wherein:
the criterion relates to a relevancy of a product to the user; and
the task relates to soliciting an opinion of the user with respect to an aspect of the product.

7. A system comprising:
a rule-reception module to, using a processor, receive a rule from a second system, the rule specifying a criterion for a selection of a user from a plurality of users of a first system;
a user-subset-identification module to select, using a processor, the user from the plurality of users, the selecting based on the criterion, the selecting including searching a record of a database, the record containing data pertaining to an activity of the user with respect to the first system, the database being inaccessible to the second system;
a user-notification module to forward a request from the second system to the user, the request requesting that the user perform a task; and
a result-reporting module to send a result to the second system, the result including information pertaining to a performance of the task by the user.

8. The system of claim 7, further comprising:
an information-characterization module to send a summary of the data to the second system, the summary preserving an anonymity of the user; and
wherein the criterion for the selection of the user is based on the summary.

9. The system of claim 7, further comprising:
a user-monitoring module to monitor a performance of the task by the user; and
wherein the result includes information pertaining to the monitoring of the performance of the task by the user.

10. The system of claim 7, further comprising:
a reward-determination module to determine a reward to offer to the user in exchange for the performance of the task by the user;
a user-notification module to notify the user of the reward; and
a reward-distribution module to provide the reward to the user in response to the performance of the task by the user.

11. The system of claim 7, wherein:
the first system is a network-based publication system;
the activity is at least one of a buying of a product using the first system and a selling of the product using the first system; and
the task relates to the product.

12. The system of claim 7, wherein:
the criterion relates to a relevancy of a product to the user; and
the task relates to soliciting an opinion of the user with respect to an aspect of the product.

13. A non-transitory machine readable medium embodying a set of instructions that, when executed by a processor, causes the processor to perform operations, the operations comprising:
at a first system:
receiving a rule from a second system, the rule specifying a criterion for a selection of a user from a plurality of users of the first system;
selecting, using a processor, the user from the plurality of users, the selecting based on the criterion, the selecting including searching a record of a database, the record containing data pertaining to an activity of the user with respect to the first system, the database being inaccessible to the second system;
forwarding a request from the second system to the user, the request requesting that the user perform a task; and
sending a result to the second system, the result including information pertaining to a performance of the task by the user.

14. The non-transitory machine readable medium of claim 13, further comprising:
at the first system:
sending a summary of the data to the second system, the summary preserving an anonymity of the user; and
wherein the criterion for the selection of the user is based on the summary.

15. The non-transitory machine readable medium of claim 13, further comprising:
monitoring a performance of the task by the user; and
wherein the result includes information pertaining to the monitoring of the performance of the task by the user.

16. The non-transitory machine readable medium of claim 13, further comprising:
at the first system:
determining a reward to offer to the user in exchange for the performance of the task by the user;
notifying the user of the reward; and
providing the reward to the user in response to the performance of the task by the user.

17. The non-transitory machine readable medium of claim 13, wherein:
the first system is a network-based publication system;
the activity is at least one of a buying of a product using the first system and a selling of the product using the first system; and
the task relates to the product.

18. The non-transitory machine readable medium of claim 13, wherein:
the criterion relates to a relevancy of a product to the user; and
the task relates to soliciting an opinion of the user with respect to an aspect of the product.
